(19) United States
(12) Patent Application Publication
(10) Pub. No.: US 2020/0126043 A1
(43) Pub. Date: Apr. 23, 2020

(54) SYSTEM AND METHOD TO IDENTIFY RELATIVE AVAILABILITY FOR A PRE-DETERMINED TEAM

(71) Applicant: INTERNATIONAL BUSINESS MACHINES CORPORATION, Armonk, NY (US)

(72) Inventors: Ami H. Dewar, Durham, NC (US); Rachael M. Dickens, Raleigh, NC (US); Thomas J. Blanchflower, Raleigh, NC (US); David A. Brooks, Providence, MA (US); Ethan A. Geyer, Mebane, NC (US)

(21) Appl. No.: 16/168,409

(22) Filed: Oct. 23, 2018

(51) Int. Cl. G06Q 10/10; G06F 3/0481

(52) U.S. Cl. CPC G06Q 10/1093; G06F 3/04817

(57) ABSTRACT

A computer-implemented system, method and computer program product to identify relative availability for a pre-determined team, by: determining an availability intent for each member of the team; determining at least one availability desire for each member of the team; determining an inferred availability state for each member of the team; and conveying the relative availability for each member of the team based on the availability intent, the availability desire, and the inferred availability state by displaying a visual indicator. The visual indicator includes an avatar for a team member decorated by a dot showing the team member's current availability and an arc showing the team member's availability for a period of time extending from the current availability into the future, wherein the dot and the arc have a fill or color representing the team member's availability, and the arc has a length representing the period of time in the future.

### BACKGROUND

The present invention relates generally to a system and method to identify relative availability for a pre-determined team.

Often, as users are collaborating, they need to pull their peers into collaborative activities, such as a meeting or work session. However, there is typically only a few limited ways of identifying a user's availability. For example, a user may manually set an “availability indicator” (e.g., such as that they are “available”, “away”, “do-not disturb”, etc.). In another example, a program or tool may automatically assert the user's availability (e.g., a calendar shows the user is in a meeting, or an instant messaging application shows that the user has been inactive for an hour, or a telephony application shows that the user is on a call).

Many times, a person may not be able to surmise which user across a set of users, such as a member of a team, might be the most “available” to participate in a collaborative activity. Interrupting a user who is already multitasking, or otherwise involved in other activities, will only prove very disruptive to this user, when in all likelihood there is another user who has greater availability.

What is needed, then, are improved systems and methods to identify relative availability for a pre-determined team. The present invention satisfies this need.

### SUMMARY

The invention provided herein has many embodiments useful, for example, in implementing a system, method and computer program product to identify relative availability for a pre-determined team, by: determining an availability intent for each member of the team; determining at least one availability desire for each member of the team; determining an inferred availability state for each member of the team; and conveying the relative availability for each member of the team based on the availability intent, the availability desire, and the inferred availability state.

The availability intent, the availability desire, and the inferred availability state are used to determine a composite availability state for each member of the team, wherein the composite availability state identifies the relative availability for each member of the team.

One or more data sources of availability information are accessed to determine the availability intent, the availability desire, and the inferred availability state for each member of the team. The one or more data sources of availability information include: participation in a meeting, participation in a conversation, participation in a video or audio conference session, participation in a collaborative activity, or participation in another activity.

The relative availability for each member of the team is conveyed by displaying a visual indicator of the relative availability of each member of the team, wherein the visual indicator is updated as the relative availability changes. The visual indicator is comprised of an avatar for a team member decorated by a dot showing the team member's current availability and an arc showing the team member's availability for a period of time extending from the current availability into the future, wherein the dot and the arc have a fill or color representing the team member's availability, and the arc has a length representing the period of time in the future.

### BRIEF DESCRIPTION OF THE DRAWINGS

Referring now to the drawings in which like reference numbers represent corresponding parts throughout:

FIG. 1 is a pictorial representation of an illustrative cloud computing environment used for implementing the system and method to identify relative availability for a pre-determined team.

FIG. 2 is a block diagram illustrating how the system and method to identify relative availability for a pre-determined team is implemented, according to one embodiment.

FIGS. 3A and 3B illustrate a use case for the system and method to identify relative availability for a pre-determined team, according to one embodiment.

FIG. 4 illustrates how runtime processing is performed to identify relative availability for a pre-determined team, according to one embodiment.

FIG. 5 illustrates a set of functional abstraction layers provided by the cloud computing environment.

### DETAILED DESCRIPTION

In the following description, reference is made to the accompanying drawings which form a part hereof, and in which is shown by way of illustration one or more specific embodiments in which the invention may be practiced. It is to be understood that other embodiments may be utilized, and structural and functional changes may be made without departing from the scope of the present invention.

Overview

The present invention discloses a system and method to identify relative availability for a pre-determined team. One embodiment provides an availability assistant used with a collaboration platform. The availability assistant processes various data sources of availability information from the collaboration platform using cognitive services to identify the relative availability for each member of the pre-determined team.

Identifying relative availability information may be accomplished by a variety of techniques. These techniques include determining an availability intent for each team member, determining at least one availability desire for each team member, and/or determining an inferred availability state for each team member. The availability intent, the availability desire, and/or the inferred availability state are used to determine a composite availability state for each member of the team. The composite availability state identifies the relative availability for each member of the team.

In one embodiment, IBM® Connections™ is used as the collaboration platform that integrates email, calendar, activity and task management, instant messaging, file sharing, collaborative document editing, and more, into a unified solution. Teams can access these capabilities from a personalized workspace to communicate, manage work, and share tools and resources. However, other collaboration platform may be used as well.

In one embodiment, IBM® Watson™ Cognitive Services are used as the cognitive services, although other cognitive services may be used as well. The IBM® Watson™ Cognitive Services perform a number of different functions as described below.

Language extraction and understanding may be performed using the IBM® Watson™ Natural Language Understanding, which analyzes text to extract meta-data from content such as entities, topics, concepts, etc. The IBM® Watson™ Natural Language Understanding also returns both overall sentiment and emotion for the text, and targeted sentiment and emotion towards keywords in the text for deeper analysis. In addition, the IBM® Watson™ Natural Language Understanding understands text in multiple languages.

Speech-to-text may be performed using the IBM® Watson™ Speech to Text that converts audio and voice into written text.

Image and video classification may be performed using the IBM® Watson™ Visual Recognition that understands the content of images and video. It can analyze images and video for scenes, objects, faces, colors, food, text, explicit content and other subjects that can provide insights into visual content.

Cloud Computing Environment

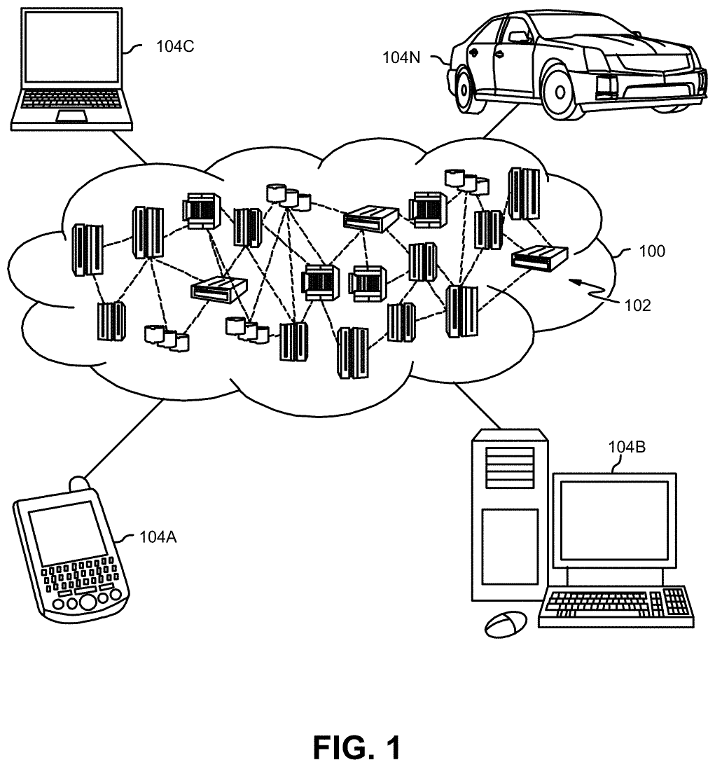

FIG. 1 is a pictorial representation of an illustrative cloud computing environment 100 used for implementing the system and method to identify relative availability for a pre-determined team, according to one embodiment.

As shown, a cloud computing environment 100 includes one or more cloud computing nodes 102 with which local computing devices used by cloud consumers, such as, for example, personal digital assistant (PDA) or cellular telephone 104A, desktop computer 104B, laptop computer 104C, and/or automobile computer system 104N may communicate. Nodes 102 may communicate with one another. They may be grouped (not shown) physically or virtually, in one or more networks, such as Private, Community, Public, or Hybrid clouds, or a combination thereof. This allows cloud computing environment 100 to offer infrastructure, platforms and/or software as services for which a cloud consumer does not need to maintain resources on a local computing device. It is understood that the types of computing devices 104A-N shown in FIG. 1 are intended to be illustrative only and that computing nodes 102 and cloud computing environment 100 can communicate with any type of computerized device over any type of network and/or network addressable connection (e.g., using a web browser).

The computing nodes 102 and/or computing devices 104A-N perform various functions and steps as described in more detail below.

Availability Assistant

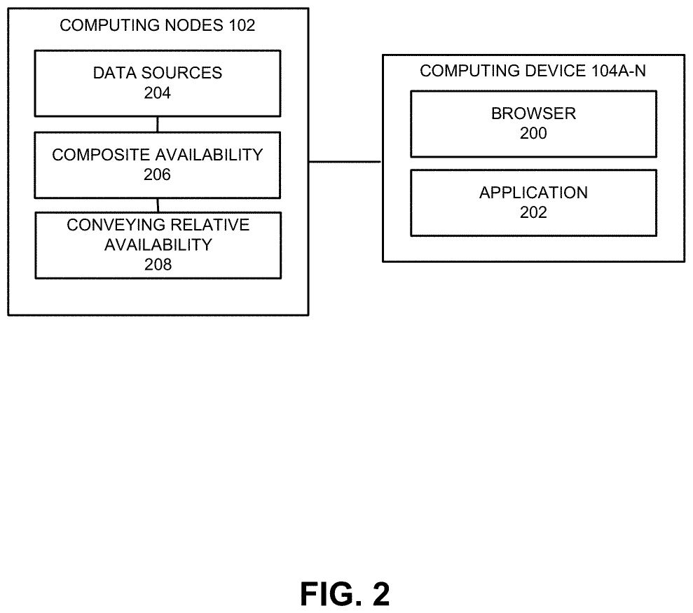

FIG. 2 is a block diagram illustrating how the system and method to identify relative availability for a pre-determined team are implemented, according to one embodiment. In this embodiment, the system and method are implemented by:
a browser 200 or application 202 executed on a user's computing device 104A-N invokes an availability assistant with a relative availability query and displays results therefrom; and
the computing nodes 102 perform a plurality of functions or steps 204-208 of the availability assistant in processing the relative availability query and then present the results therefrom to the browser 200 or application 202 on the computing device 104A-N.

These functions and steps 204-208 are described in more detail below. In alternative embodiments, these functions and steps 204-208 may be wholly or partially performed on the computing nodes 102 and/or computing devices 104A-N.

In one embodiment, the relative availability query might be initiated when the user is adding another member to the team (e.g., while examining their contacts), or when the user is inviting another team member into a chat or other collaborative activity (e.g., while examining their team). In other embodiments, the relative availability query might be initiated when the user performs other actions on the computing device 104A-N.

In a Data Sources function or step 204, the computing nodes 102 perform the function or step of accessing one or more data sources of availability information in order to identify the relative availability for each member of the pre-determined team.

The data sources accessed include the team members' calendars, conversations, sessions, collaborative activities, and other activities. In one embodiment, the data sources of availability information include: participation in a meeting, participation in a conversation, participation in a video or audio conference session, participation in a collaborative activity, or participation in another activity. Other data sources may be used as well.

Identifying relative availability may be accomplished by a variety of techniques. The availability information retrieved from the data sources is processed to obtain cognitive data for determining an availability intent for each team member, determining at least one availability desire for each team member, and/or determining an inferred availability state for each team member.

In a Composite Availability function or step 206, the computing nodes 102 perform the function or step of determining a composite availability state for each team member using the availability intent, the availability desire, and/or the inferred availability state. The composite availability state identifies the relative availability for each team member.

In a Conveying Relative Availability function or step 208, the computing nodes 102 perform the function or step of conveying the relative availability for each member of the team, for example, by displaying a visual indicator of the relative availability of each member of the team.

In one embodiment, the visual indicators may show which of the team members are determined to be the “most” and “least” available (and which of the team members are determined to be somewhere between the “most” and “least” available) at the time the query is performed.

Typically, the visual indicators are not about precision, but rather the intent is to provide general feedback to a user as to the relative availability of each of the team members. Preferably, the visual indicators give the user a better sense of who would be least disrupted if they are invited into a chat or other collaborative activity.

The visual indicators could be provided on their own or could be provided in addition to already-used visual indicators. For example, the visual indicators could be displayed with avatars already used by the team members.

In one embodiment, the visual indicators are dynamic, in that they are updated as the relative availability changes. Consequently, these functions or steps 204-208 may be repeated as necessary, and any one or more of the functions or steps 204-208 may be omitted as required.

Use Case

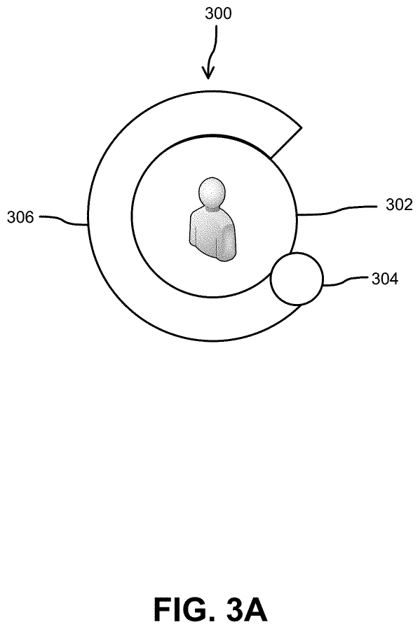

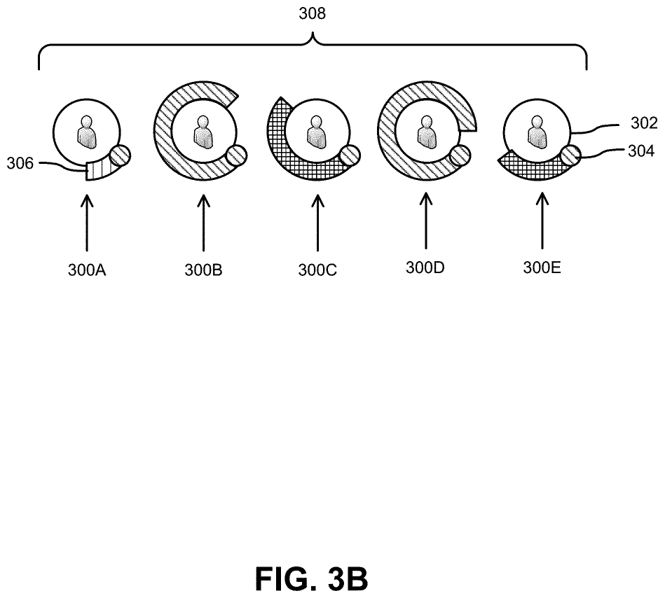

Consider the following use case to identify relative availability for a pre-determined team. This use case is illustrated in FIGS. 3A and 3B.

FIG. 3A illustrates an exemplary visual indicator 300, according to one embodiment. The visual indicator 300 is comprised of an avatar 302 for a team member decorated by a dot 304 showing the team member's current availability and an arc 306 showing the team member's availability for a period of time extending from the current availability into the future. Both the dot 304 and the arc 306 may have a fill or color representing the team member's availability, e.g., red for unavailable, yellow for possibly available, and green for available. In addition, the arc 306 may have a length representing the period of time into the future, e.g., the next hour, the next 12 hours, the next 24 hours, etc. Thus, for each of the team members, the user can gauge the current availability and the availability for the period of time into the future at a glance.

FIG. 3B illustrates a plurality of the visual indicators 300A, 300B, 300C, 300D, 300E for a team 308, according to one embodiment. In this example, the fill patterns for the dots 304 of the visual indicators 300A, 300B, 300C, 300D, 300E represent the color green, while the fill patterns for the arcs 306 of the visual indicators 300A, 300B, 300C, 300D, 300E represent the colors of red, green, yellow, green and yellow, respectively.

Consequently, visual indicator 300A (dot 304=green; arc 306=red) represents the least available of the team members, who is involved in several other interactive activities; visual indicators 300B (dot 304=green; arc 306=green) and 300D (dot 304=green; arc 306=green) represent the most available of the team members; and visual indicators 300C (dot 304=green; arc 306=yellow) and 300E (dot 304=green; arc 306=yellow) represent team members that are involved in at least one other activity but have more availability than the team member represented by visual indicator 300A and less availability than the team members represented by visual indicators 300B and 300D.

Thus, all of the team members are currently available as shown by the dots 304, but a user looking to engage a team member or sub-set of team members in a collaborative activity at the current time can see, from the colors and lengths of the arcs 306 encircling the avatars 300, that team members 300B and 300D are the most available, and that team member 300A is the least available. These visual indicators 300A, 300B, 300C, 300D, 300E are dynamic in that they are updated as the relative availability of the team members change.

Runtime Processing

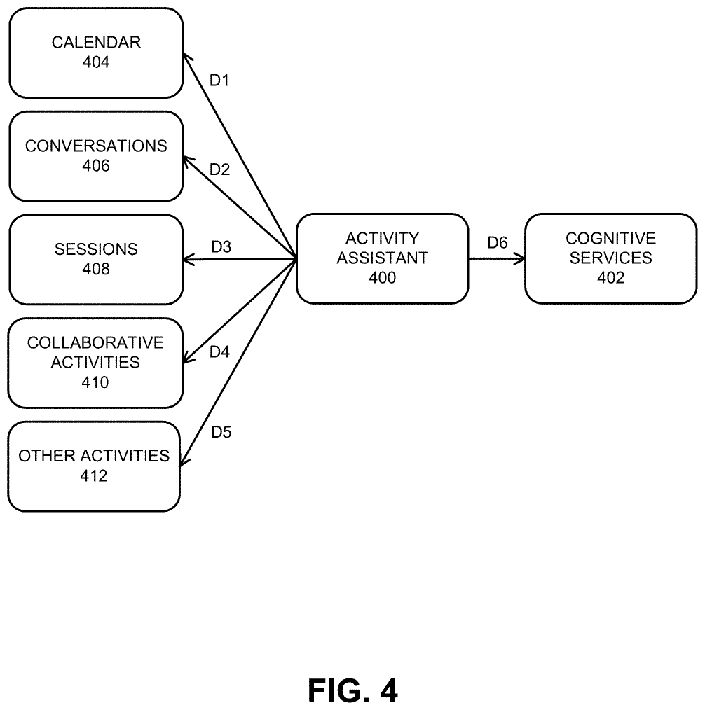

FIG. 4 illustrates how runtime processing is performed to identify relative availability for a pre-determined team, according to one embodiment.

The runtime processing includes an Activity Assistant 400, performed by the computing nodes 102, which interfaces to Cognitive Services 402, performed by the computing nodes 102, to perform a discovery process using cognitive data to determine the relative availability of team members, as described below.

The Availability Assistant 400 accesses various data sources of availability information to identify the relative availability for each member of the pre-determined team. In step D1, information is retrieved, for example, from the team members' Calendars 404. In step D2, information is retrieved from Conversations 406, which may comprise email, chats, texts, instant messages, etc. In step D3, information is retrieved from Sessions 408, which may comprise video sessions, web conferences, etc. In step D4, information is retrieved from Collaborative Activities 410, which may comprise co-editing activities, etc. In step D5, information is retrieved from Other Activities 412, which may comprise non-collaborative activities, etc.

In step D6, the Availability Assistant 400 uses the Cognitive Services 402 to process the retrieved information, wherein the Cognitive Services 402 perform natural language understanding for language extraction and understanding to obtain cognitive data for determining an availability intent for each team member, determining at least one availability desire for each team member, and/or determining an inferred availability state for each team member.

In one embodiment, the Cognitive Services 402 analyzes text to extract meta-data from content such as entities, topics and concepts. The Cognitive Services 402 also return both overall sentiment and emotion for the text, and targeted sentiment and emotion towards keywords in the text for deeper analysis. In addition, the Cognitive Services 402 understand text in multiple languages.

In addition, the Cognitive Services 402 may perform image and video classification to obtain cognitive data for determining an availability intent for each team member, determining at least one availability desire for each team member, and/or determining an inferred availability state for each team member. In one embodiment, the Cognitive Services 402 perform visual recognition for understanding the content of video and images. The Cognitive Services 402 can analyze video and images for scenes, objects, faces, colors, food, text, explicit content and other subjects that can provide insights into visual content.

The availability intent, the availability desire, and/or the inferred availability state are used by the Activity Assistant 400 to determine a composite availability state for each team member, wherein the composite availability state identifies the relative availability for each team member.

The Activity Assistant 400 then conveys the relative availability for each member of the team, for example, by displaying a visual indicator of the relative availability of each member of the team.

Statutory Subject Matter

It can be seen that the present invention provides a number of benefits and advantages:
One benefit is the ability to arrange for team members to participate in collaborative activities, such as meetings or work sessions.
Another benefit is the ability to identify those team members that are most and least available to participate in the collaborative activities, in order to avoid interrupting or disrupting team members that are least available.
Yet another benefit is the creation of an availability assistant that processes various data sources of availability information from the collaboration platform using cognitive services to identify the relative availability for each member of a pre-determined team.
Another benefit is the variety of techniques used for identifying the relative availability for each team member, including determining an availability intent for each team member, determining at least one availability desire for each team member, and/or determining an inferred availability state for each team member.
Yet another benefit is the determination of a composite availability state for each member of the team from the availability intent, the availability desire, and/or the inferred availability state, wherein the composite availability state identifies the relative availability for each member of the team.

These benefits and advantages include improvements to the technology or technical field of collaboration platforms, and more specifically, for identifying the relative availability of a pre-determined team on a collaboration platform. These benefits and advantages also include improvements to the functioning of the collaboration platform, including the cloud computing environment 100 generally and the computing nodes 102 specifically, as compared to prior computer-implemented methods and systems for identifying the availability of persons on a collaboration platform.

Both generally and specifically, these steps and functions of the computer-implemented method and system comprise specific improvements other than what is well-understood, routine and conventional in the field. Moreover, these steps and functions of the computer-implemented method and system add unconventional steps to a particular useful application.

Cloud Computing

It is to be understood that this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring again to FIG. 1, illustrative cloud computing environment 100 is depicted. As shown, cloud computing environment 100 includes one or more cloud computing nodes 102 with which local computing devices used by cloud consumers, such as, for example, personal digital assistant (PDA) or cellular telephone 104A, desktop computer 104B, laptop computer 104C, and/or automobile computer system 104N may communicate. Nodes 102 may communicate with one another. They may be grouped (not shown) physically or virtually, in one or more networks, such as Private, Community, Public, or Hybrid clouds as described hereinabove, or a combination thereof. This allows cloud computing environment 100 to offer infrastructure, platforms and/or software as services for which a cloud consumer does not need to maintain resources on a local computing device. It is understood that the types of computing devices 104A-N shown in FIG. 1 are intended to be illustrative only and that computing nodes 102 and cloud computing environment 100 can communicate with any type of computerized device over any type of network and/or network addressable connection (e.g., using a web browser).

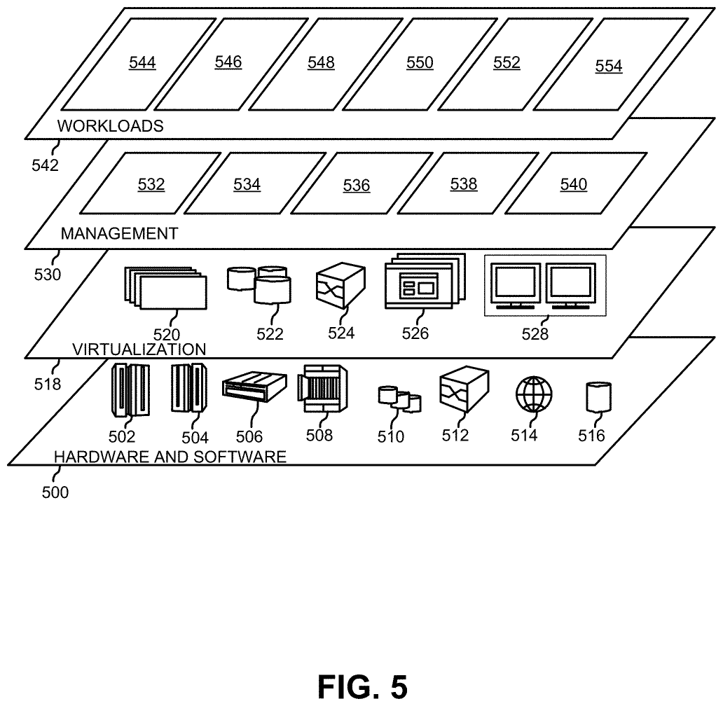

Referring now to FIG. 5, a set of functional abstraction layers provided by cloud computing environment 100 (FIG. 1) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 500 includes hardware and software components. Examples of hardware components include: one or more computers such as mainframes 502, RISC (Reduced Instruction Set Computer) architecture based servers 504, servers 506, and blade servers 508; storage devices 510; and networks and networking components 512. In some embodiments, software components include network application server software 514 and database software 516.

Virtualization layer 518 provides an abstraction layer from which the following examples of virtual entities may be provided: virtual servers 520; virtual storage 522; virtual networks 524, including virtual private networks; virtual applications and operating systems 526; and virtual clients 528.

In one example, management layer 530 may provide the functions described above. Resource provisioning 532 provides dynamic procurement of computing resources and other resources that are utilized to perform tasks within the cloud computing environment 100. Metering and pricing 534 provide cost tracking as resources are utilized within the cloud computing environment 100, and billing or invoicing for consumption of these resources. In one example, these resources may include application software licenses. Security provides identity verification for cloud consumers and tasks, as well as protection for data and other resources. User portal 536 provides access to the cloud computing environment 100 for consumers and system administrators. Service level management 538, which includes containers, provides cloud computing resource allocation and management such that required service levels are met. Service Level Agreement (SLA) planning and fulfillment 540 provide pre-arrangement for, and procurement of, cloud computing resources for which a future requirement is anticipated in accordance with an SLA.

Workloads layer 542 provides examples of functionality for which the cloud computing environment 100 may be utilized. Examples of workloads, tasks and functions which may be provided from this layer include: mapping and navigation 544; software development and lifecycle management 546; virtual classroom education delivery 548; data analytics processing 550; transaction processing 552; etc. More specifically, this layer includes the workloads, tasks and functions of an availability assistant 554 for identifying relative availability for a pre-determined team as described above.

Computer Program Product

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart illustrations and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart illustrations and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart illustrations and/or block diagram block or blocks.

The flowchart illustrations and block diagrams in the Figures illustrate the architecture, functionality, and operation of possible implementations of systems, methods, and computer program products according to various embodiments of the present invention. In this regard, each block in the flowchart illustrations or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

### CONCLUSION

This concludes the description of the various embodiments of the present invention. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Since many embodiments of the invention can be made without departing from the spirit and scope of the invention, the invention resides in the claims hereinafter appended.

What is claimed is:

1. A computer-implemented system, comprising:
one or more computers programmed for identifying relative availability for a pre-determined team, by:
determining an availability intent for each member of the team;
determining at least one availability desire for each member of the team;
determining an inferred availability state for each member of the team; and
conveying the relative availability for each member of the team based on the availability intent, the availability desire, and the inferred availability state.

2. The system of claim 1, wherein the availability intent, the availability desire, and the inferred availability state are used to determine a composite availability state for each member of the team, and the composite availability state identifies the relative availability for each member of the team.

3. The system of claim 1, wherein one or more data sources of availability information are accessed to determine the availability intent, the availability desire, and the inferred availability state.

4. The system of claim 3, wherein the one or more data sources of availability information include:
participation in a meeting,
participation in a conversation,
participation in a video or audio conference session,
participation in a collaborative activity, or
participation in another activity.

5. The system of claim 1, wherein conveying the relative availability for each member of the team comprises displaying a visual indicator of the relative availability of each member of the team.

6. The system of claim 5, wherein the visual indicator is updated as the relative availability changes.

7. The system of claim 5, wherein the visual indicator is comprised of an avatar for a team member decorated by a dot showing the team member's current availability and an arc showing the team member's availability for a period of time extending from the current availability into the future.

8. The system of claim 7, wherein the dot and the arc have a fill or color representing the team member's availability.

9. The system of claim 7, wherein the arc has a length representing the period of time in the future.

10. A computer-implemented method, comprising:
identifying relative availability for a pre-determined team on one or more computers, by:
determining an availability intent for each member of the team;
determining at least one availability desire for each member of the team;
determining an inferred availability state for each member of the team; and
conveying the relative availability for each member of the team based on the availability intent, the availability desire, and the inferred availability state.

11. The method of claim 10, wherein the availability intent, the availability desire, and the inferred availability state are used to determine a composite availability state for each member of the team, and the composite availability state identifies the relative availability for each member of the team.

12. The method of claim 10, wherein one or more data sources of availability information are accessed to determine the availability intent, the availability desire, and the inferred availability state.

13. The system of claim 12, wherein the one or more data sources of availability information include:
participation in a meeting,
participation in a conversation,
participation in a video or audio conference session,
participation in a collaborative activity, or
participation in another activity.

14. The method of claim 10, wherein conveying the relative availability for each member of the team comprises displaying a visual indicator of the relative availability of each member of the team.

15. The method of claim 14, wherein the visual indicator is updated as the relative availability changes.

16. The method of claim 14, wherein the visual indicator is comprised of an avatar for a team member decorated by a dot showing the team member's current availability and an arc showing the team member's availability for a period of time extending from the current availability into the future.

17. The method of claim 16, wherein the dot and the arc have a fill or color representing the team member's availability.

18. The method of claim 16, wherein the arc has a length representing the period of time in the future.

19. A computer program product, the computer program product comprising a computer readable storage medium having program instructions embodied therewith, the program instructions executable by one or more computers to cause the computers to perform a method, comprising:
identifying relative availability for a pre-determined team on one or more computers, by:
determining an availability intent for each member of the team;
determining at least one availability desire for each member of the team;
determining an inferred availability state for each member of the team; and
conveying the relative availability for each member of the team based on the availability intent, the availability desire, and the inferred availability state.

20. The computer program product of claim 19, wherein conveying the relative availability for each member of the team comprises displaying a visual indicator of the relative availability of each member of the team, and the visual indicator is comprised of an avatar for a team member decorated by a dot showing the team member's current availability and an arc showing the team member's availability for a period of time extending from the current availability into the future.
